(19) United States
(12) Patent Application Publication
(10) Pub. No.: US 2024/0345272 A1
(43) Pub. Date: Oct. 17, 2024

(54) Land Seismic Exploration Methods, Electronic Equipment and Readable Storage Media

(71) Applicant: Xiaolong TONG, Beijing (CN)

(72) Inventors: Xiaolong TONG, Beijing (CN); Weishan HAN, Beijing (CN); Yong GE, Beijing (CN); Jiabao ZHANG, Beijing (CN); Guodong MA, Beijing (CN)

(21) Appl. No.: 18/036,357

(22) PCT Filed: Jun. 1, 2022
(86) PCT No.: PCT/CN2022/096519

§ 371 Date: May 10, 2023

(30) Foreign Application Priority Data
May 30, 2022 (CN) 202210596453X

(51) Int. Cl. G01V 1/30

(52) U.S. Cl. CPC G01V 1/303; G01V 1/306; G01V 2210/127; G01V 2210/1291; G01V 2210/1295; G01V 2210/1299; G01V 2210/1425; G01V 2210/6222; G01V 2210/6224

(57) ABSTRACT

The present invention discloses a land seismic exploration method, electronic equipment and a readable storage medium, which belongs to the field of land seismic exploration technology. The land seismic exploration method, includes: detecting the first component seismic wave transmitted to the surface of the ground by the vibration generated at a preset position of the ground or surface; detection of the second component of seismic wave transmitted by the vibration to the air above the surface; Calculate the surface parameters within the set range of the preset position according to the first seismic wave and the second component of seismic wave; The underground velocity model and density model are calculated according to the surface parameters. Using the same meteorological conditions, the sound velocity and density of the air are consistent, and the second seismic wave that penetrates the earth surface and reaches the air is detected.

### CROSS-REFERENCE TO RELATED APPLICATION

This Application is a national stage application of PCT/CN2022/096519. This application claims priority from PCT Application No. PCT/CN2022/096519, filed Jun. 1, 2022, and from the Chinese patent application 202210596453X filed May 30, 2022, the content of which is incorporated herein in the entirety by reference.

### TECHNICAL FIELD

The present disclosure belongs to the domain of land seismic exploration technology, in particular relates to a land seismic exploration method, electronic equipment and a readable storage medium.

### BACKGROUND TECHNIQUE

In land seismic exploration, the geophones currently used to receive seismic waves are in direct and tightly contact with the surface, such as insert into the surface with a sharp tail vertebrae, or shallowly burying the surface, so that the geophones are directly coupled to the earth. Through explosives or vibrators to excite artificial seismic waves to propagate underground, seismic waves encounter underground structures and are reflected, returned to the surface, received and recorded by surface geophones, and seismic data are obtained. Through a series of mathematical and physical algorithms, these data finally obtained the imaging results of underground structures, which became the basis for oil companies to search for oil.

In the current processing of land seismic data, there is no requirement for accurate properties of the land surface. Only a simple average effect can be used to estimate a near-surface average velocity, or a simple near-surface velocity can be inverted: As a result, the personal experience of data processors is highly dependent, and there are personal subjective factors in the data processing results and the uncertainty caused by them, resulting in unreliable imaging results. As a result, the error between the results of subsequent processing and the actual engineering and drilling is very large, which brings huge risks to oil exploration and development.

### CONTENTS OF THE DISCLOSURE

### (1) The Purpose of the Present Disclosure

is to provide a land geological survey method and survey equipment to solve the problem that the prior art can only use a simple average effect to estimate a near-surface average velocity, or invert a simple near-surface velocity, resulting in unreliable subsequent imaging results.

### (2) Technical Solutions

The present disclosure provides a land seismic exploration method, includes:
Detect the first seismic wave transmitted to the surface by vibrations generated underground or at preset locations on the surface;
detection of the second seismic wave transmitted by the vibration to the air above the surface;
Calculate the surface parameters within the set range of the preset position according to the first seismic wave and the second seismic wave;

The underground velocity model and density model are calculated according to the surface parameters.

In an optional embodiment, the surface parameters within the set range of the preset position calculated according to the first seismic wave and the second seismic wave comprise:
Detection of the first seismic wave includes detecting the energy of the first seismic wave;
Detecting the second seismic wave includes detecting the energy of the second seismic wave;

According to the energy of the first seismic wave and the energy of the second seismic wave, the actual reflection coefficient of the air and earth surface within the set range of the preset position is calculated.

In an optional embodiment, the surface parameters within the set range of the preset position calculated according to the first seismic wave and the second seismic wave comprise:
a direct or groundroll wave reaching the detection point at the preset position according to the first seismic wave and the second seismic wave;

The surface velocity within the set range of the preset position is calculated according to the direct wave or groundroll wave.

In an optional embodiment, the surface parameters within the set range of the preset position calculated according to the first seismic wave and the second seismic wave comprise:

According to the calculation formula of the surface density, the surface density within the set range of the preset position is obtained,

The formula for calculating the surface density is:

$${ρ}_{g} = \frac{{ρ}_{air} {v}_{air} ( 1 - {r}_{g} )}{{v}_{g} ( 1 + {r}_{g} )}$$

wherein ρ_{g} is the surface density, v_{g} is the surface velocity, r_{g} is the actual reflection coefficient, vₐᵢᵣ is the air velocity within the set range of the preset position, and ρₐᵢᵣ is the air density within the set range of the preset position.

In an optional embodiment, the calculation of the underground velocity model and density model according to the surface parameters comprises:
a plurality of set positions are arranged on the surface to detect the first seismic wave and the second seismic wave at each set location;

According to the first seismic wave and the second seismic wave at each set location, the surface density and surface velocity at each set location are obtained;
construct an initial near-surface model according to the density of air, the velocity of air, the surface density at each set location, and the surface velocity;

According to the initial near-surface model, the full waveform inversion algorithm is used to obtain the underground velocity model and the density model, wherein the underground velocity model obtained by inversion matches the actual underground velocity, and the inverted underground density model matches the actual underground density model.

In an optional embodiment, the initial near-surface model is an initial near-surface model covering the air layer, the air layer contains at least two parameters of air density and air velocity, and the upper boundary of the air layer is set as the absorption boundary.

In an optional embodiment, according to the initial near-surface model, the full waveform inversion algorithm is used to obtain a subsurface velocity model and a density model includes:

The source wavelet function is obtained by inverting the wavelet shape of each excitation source by inversion first arrive wave of the source shot, and the source wavelet function is obtained according to the source wavelet function at the preset position where the source vibrates, then the full waveform inversion algorithm is used to obtain the underground velocity model and density model according to the source wavelet function, so that the forward propagation wave field results are consistent with the actual wavefield.

In an optional embodiment, according to the initial near-surface model, the full waveform inversion algorithm is used to obtain a subsurface velocity model and a density model includes:

The second seismic wave is used to shape the first seismic wave wavelet to obtain the comprehensive observation data of the first seismic wave and the second seismic wave, and the comprehensive observation data is used to ensure that the detection point term of the forward data in the full waveform inversion is consistent with the actual data.

In an optional embodiment, according to the initial near-surface model, the full waveform inversion algorithm is used to obtain a subsurface velocity model and a density model includes:

The filter operator of the detection point at the set position of the surface is jointly calculated by the second seismic wave and the first seismic wave, and the filter operator is used for the detection point term of the simulation in the full waveform inversion, so as to eliminate the inconsistency between the forward data waveform and the actual data waveform caused by the inconsistency of coupling of the surface detection point.

Further, the present disclosure also provides an electronic device, includes: a processor, a memory and a program or instruction stored in the memory and may run within the processor, the program or instruction is executed by the processor when the steps to realize the land seismic exploration method as described.

In an optional embodiment, the electronic device further comprises:
Geophones for setting at the surface and detecting the first seismic waves transmitted by underground vibrations to the surface; and
A pickup for setting at a distance from the surface and detecting the second seismic wave transmitted into the air by the vibration.

In an optional embodiment, the electronic device further comprises: a sound-insulating case, a sleeve structure,

The soundproof shell is provided for erection disposed on the surface, and the sound-insulating case is used to be erected on the ground surface, and the sound pickup is arranged at one axial end of the sound-insulating case Inside.

In an optional embodiment, the electronic device further comprises a linear amplifier, an analog-to-digital conversion module, an acquisition control module, the linear amplifier is connected to the analog-to-digital conversion module, the analog-to-digital conversion module is connected to the acquisition control module, and the linear amplifier is connected to the pickup or the detector.

Further, the present disclosure also provides a readable storage medium, the readable storage medium stores a program or instruction, the program or instruction is executed by the processor when implementing the steps of the land seismic exploration method as described.

### (3) Beneficial Effects

The above technical solution of the present disclosure has the following beneficial technical effects:

The present disclosure in the underground or the preset position of the surface to produce vibration, and then detect the first seismic wave transmitted by the vibration to the surface at the same time, using the same meteorological conditions, the sound velocity and density of the air is consistent, detect the second seismic wave that penetrates the surface to the air, so as to achieve the purpose of inverting the surface parameters according to the first seismic wave and the second seismic wave, such as surface density, surface velocity and actual reflection coefficient and other surface parameters, to achieve the purpose of land exploration surface consistency, A more accurate underground velocity model and density model are obtained, and finally the underground structure without multiple value solutions is provided, which solves the problem that there are personal subjective factors and uncertainty caused by data processing results, resulting in unreliable imaging results.

### DESCRIPTION OF THE DRAWINGS

FIG. 1 is an overall flow chart of the land seismic exploration method of a specific embodiment of the present disclosure;

FIG. 2 is a detailed flow chart of the land seismic exploration method of a specific embodiment of the present disclosure;

FIG. 3 is a flowchart of the land seismic exploration method combined with a full-waveform inversion algorithm for a specific embodiment of the present disclosure;

FIG. 4 is a flowchart of the main preparation process of the land seismic exploration method of the embodiment of the present disclosure before the full-waveform inversion algorithm;

FIG. 5 is a flowchart of the detailed preparation process of the land seismic exploration method in a specific embodiment of the present disclosure before the full-waveform inversion algorithm;

FIG. 6 is a schematic diagram of the interconnection of the linear amplifier, analog-to-digital conversion module, acquisition control module, pickup and detector of the electronic device of the present disclosure in a specific embodiment;

FIG. 7 is a schematic structure diagram of the acoustic shell of the land seismic exploration equipment in a specific embodiment of the present disclosure;

FIG. 8 is the E-direction schematic in FIG. 7.

### DETAILED WAYS

In order to make the object of the present disclosure, the technical solution and the advantages more clear, the present disclosure is further elaborated in conjunction with specific embodiments and with reference to the accompanying drawings. It should be understood that these descriptions are only exemplary and do not intend to limit the areas of the present disclosure. Further, in the following description, the description of well-known structures and techniques is omitted to avoid unnecessary confusion of the concepts of the present disclosure.

A schematic view of the layer structure according to an embodiment of the present disclosure is shown in the drawings. These plots are not drawn to scale, where certain details are zoomed in for clarity and some details may be omitted. The various regions, the shape of the layer shown in the figure and the relative size and position relationship between them are only exemplary, in practice may be deviated due to manufacturing tolerances or technical limitations, and those skilled in the art may additionally design the area/layer having different shapes, sizes, and relative positions according to actual needs.

Obviously, the described embodiments are a subset of embodiments of the present disclosure, but not all embodiments. Based on the embodiments in the present disclosure, all other embodiments obtained by those of ordinary skill in the art without making creative labor, belong to the area protected by the present disclosure.

Further, the technical features involved in different embodiments of the present disclosure described below may be combined with each other as long as they do not constitute a conflict with each other.

The present disclosure will be described in more detail below with reference to the accompanying drawings. In each drawing, the same component is represented by similar drawing markers. For clarity, the sections in the drawings are not drawn to scale.

For existing components that do not involve improvement points of the present disclosure, they will be briefly introduced or not introduced, but focusing on the component components that are improved relative to the prior art.

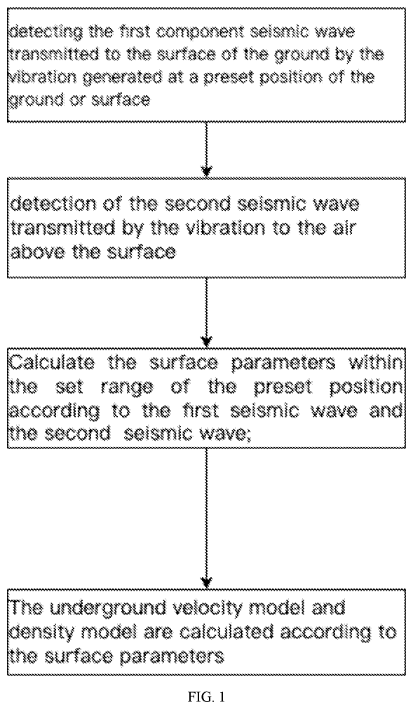

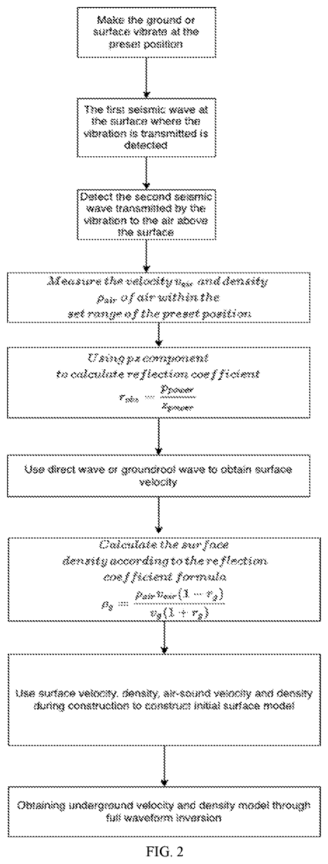

Referring to FIG. 1 and FIG. 2, the present embodiment provides a land seismic exploration method, includes:

Vibration is generated at a predetermined position underground or on the surface, where the preset location is the source of the seismic. In addition, the vibration generated by the preset position here can be caused by the explosion underground with explosives, or the vibration generated by the vibroseis at the surface.
Detection of the first seismic wave transmitted by the vibration to the surface;
Detection of second seismic waves transmitted by vibration to the air above the surface;
Calculate surface parameters within the set range of the preset location according to the first seismic wave and the second seismic wave, such as the actual reflection coefficient, surface velocity and surface density;
Calculate subsurface velocity models and density models based on surface parameters.

It should be noted that the surface referred to in the present disclosure refers to the surface of the land.

In addition, the first seismic wave here is the earth surface seismic wave component, and the second seismic wave is the seismic wave component that penetrates the earth surface reached air.

In addition, the first seismic wave transmitted to the surface of the detection of vibration can be a plurality of detection points at the surface, and each detection point is equipped with a corresponding geophone, through which the first seismic wave transmitted to the surface of the vibration is detected; Similarly, the second seismic wave transmitted by the vibration to the air above the surface can be detected by multiple detection devices, such as pickups, at a preset height from the ground, through which the second seismic wave is detected.

In addition, the setting range of the preset position here can refer to the near-surface range of direct waves passing through during the propagation from the source to each geophone, which includes the depth and distance of the travel, and the mesh selection of this range is related to the frequency of the underground velocity model and density model achieved by the full-wave inversion, that is, related to the frequency of the inversion. The minimum grid size of the set range is a quarter wavelength, that is, the grid size in the range is:

$$\frac{{v}_{min}}{{f}_{max} 4}$$

where vₘᵢₙ is the wave propagation velocity and fₘₐₓ is the inversion frequency.

The inventor of the present disclosure found that the main reason for the fact that there is no requirement for accurate properties of the land surface is now proposed, and can only use a simple average effect to estimate a near-surface average velocity, or invert a simple near-surface velocity is that the physical properties of the land surface are quite different from a time perspective or a spatial point of view. For example, at the same surface point, with the change of temperature, the water in the soil freezes in the morning and melts at noon; In different locations, there are grass and gravel, resulting in serious inconsistencies in surface conditions. Due to the lack of direct surface observational evidence, this inconsistency is difficult to quantify in wave field simulations. In other words, the existing observation records are insufficient to determine the reflection coefficient at the interface between the surface and the air, so it is difficult to establish the boundary conditions for solving the wave equation. On the other hand, the conventional full-waveform inversion algorithm assumes that the wavelet morphology of the shot point (source) is also inconsistent. In practice, the sub-wavelets generated by the explosion of explosives on land or vibrators are inconsistent, and each gun point explosion or vibrator excitation changes; At the same time, the coupling of each detection point to the land cannot be completely consistent.

For the full-waveform inversion algorithm, as mentioned above, due to the inconsistency of the source and detection point wavelets, and the inconsistency of the reflection coefficient of each point on the surface, the existing inversion algorithm cannot effectively and directly solve the underground velocity model in the current land seismic data processing, and it needs to rely on the experience of the processor, resulting in extremely unstable processing effect, which directly affects the use effect of the full-waveform inversion algorithm in onshore oil exploration.

For this reason, the present disclosure in the underground or surface preset position to produce vibration, and then detect the first seismic wave transmitted by the vibration to the surface at the same time, using the same meteorological conditions, the sound velocity and density of the air is consistent, detect the second seismic wave that penetrates the surface to the air, to achieve the purpose of land exploration surface consistency.

Therefore, the physical properties such as the actual reflection coefficient, surface velocity and surface density of the earth surface can be accurately obtained, and the source wavelet and detection point wavelet are obtained by using the air coupling consistency, and the source wavelet and detection point wave operator of the surface consistency can be obtained, and a more accurate underground velocity model and density model can be obtained, and finally the underground structure without ambiguity is provided, which solves the problem of personal subjective factors and uncertainty caused by data processing results, resulting in unreliable imaging results.

Further, it should be noted that the source wavelet referred to in the present embodiment refers to the source wavelet function.

In addition, it should be noted that the detection point wavelet comprises: the first seismic wave detected at the detection point at the surface, and the second seismic wave detected by the detection point in the air above the surface.

Referring to FIG. 1 and FIG. 2, in an optional embodiment, the first seismic wave usually have dimension velocity, labeled Z, and the second seismic wave is the air seismic wave component, which may include dimension of a pressure change component and a velocity component, labeled P.

Referring to FIG. 1 and FIG. 2, in an optional embodiment, the surface parameters within the set range of the preset position are calculated according to the first seismic wave and the second seismic wave, includes: obtaining a direct wave or groundroll wave at the preset position to the detection point according to the first seismic wave and the second seismic wave, calculating the surface velocity within the set range of the preset position according to the direct wave or groundroll wave;

It should be noted that the direct wave here is the first wave that reaches the detection point after the seismic wave passes through the surface and is generated by the source at a preset location. This signal contains longitudinal wave velocity information near the surface. Full-waveform inversion or turning wave tomography can be used to build near-surface velocity models by matching the timing information of direct waves.

In addition, the groundroll wave here is a transverse wave phenomenon that propagates along the ground. This wave is characterized by low speed, high energy, and frequency variation, which can be clearly distinguished by seismic records. It contains information about the shear wave velocity near the surface. Full waveform inversion technology of elastic wave or groundroll wave dispersion analysis can be used,

Invert the near-surface shear wave velocity model by matching the waveform or dispersion relationship of the groundroll wave. Then, from the obtained shear wave velocity model, the longitudinal wave velocity model is reversed according to a certain proportion.

Referring to FIG. 1 and FIG. 2, in an optional embodiment, detecting the first seismic wave transmitted by the vibration to the surface includes detecting the energy of the first seismic wave;
Detecting the second seismic wave transmitted by the vibration to the air above the surface includes detecting the energy of the second seismic wave.

Referring to FIG. 1 and FIG. 2, in an optional embodiment, the ground surface parameters within the set range of the preset position calculated according to the first seismic wave and the second seismic wave comprise:
Detection of the first seismic wave includes detecting the energy of the first seismic wave;
Detecting the second seismic wave includes detecting the energy of the second seismic wave;

According to the energy of the first seismic wave and the energy of the second seismic wave, the actual reflection coefficient between air and earth surface within the set range of the preset position is calculated.

In an optional embodiment, the surface parameters within the set range of the preset position calculated according to the first seismic wave and the second seismic wave comprise:
a direct or groundroll wave reaching the detection point at the preset position according to the first seismic wave and the second seismic wave;

The surface velocity within the set range of the preset position is calculated according to the direct wave or groundroll wave.

As a preferred method, the circuit correction coefficient can also be obtained according to the energy of the first seismic wave, the second seismic wave and the theoretical reflection coefficient;

The actual reflection coefficient is obtained based on the energy of the first seismic wave, the second seismic wave, and the circuit correction coefficient.

Referring to FIG. 1 and FIG. 2, in an optional embodiment, the ground surface parameters within the set range of the preset position calculated according to the first seismic wave and the second seismic wave comprise:

According to the calculation formula of the surface density, the surface density within the set range of the preset position is obtained,

According to the formula for calculating the surface density (1):

$${ρ}_{g} = \frac{{ρ}_{air} {v}_{air} ( 1 - {r}_{g} )}{{v}_{g} ( 1 + {r}_{g} )}$$

Finding the surface density;
ρ_{g} is the surface density, v_{g} is the surface velocity, r_{g} is the actual reflection coefficient between air and earth surface, vₐᵢᵣ the air velocity within the set range of the preset position, and ρₐᵢᵣ is the air density within the set range of the preset position.

Specifically, the circuit correction coefficient obtained is the calibration of the linear amplification module coefficient of the detection instrument, marking v₁ the velocity of sound in the air in the standard environment and the ρ₁ density in the air in the standard environment; Select a medium with a known density velocity, such as steel plate or granite, and mark its velocity v₂ and density ρ₂;

According to the theoretical reflection coefficient calculation formula (2):

$${r}_{model} = \frac{{v}_{1} {ρ}_{1} - {v}_{2} {ρ}_{2}}{{v}_{1} {ρ}_{1} + {v}_{2} {ρ}_{2}}$$

Find the theoretical reflection coefficient r_{model}. According to the observation coefficient calculation formula (3):

$${r}_{obs} = \frac{{p}_{power}}{{z}_{power}}$$

Find the observation coefficient r_{obs}, where p_{power} is the energy of the second seismic wave and z_{power} the energy of the first seismic wave.

Then, according to the climatic conditions detected within the set range of the preset position, the air sound velocity vₐᵢᵣ and air density ρₐᵢᵣ within the set range of the preset position are obtained by using an air sound velocity density meter; In addition, the air velocity vₐᵢᵣ and air density ρₐᵢᵣ within the set range of the preset position described here may also be a set of corresponding values selected using empirical parameters.

Formula (4) is calculated according to the true reflection coefficient:

$${r}_{g} = β {r}_{o b s}$$

The true reflection coefficient r_{g} is obtained, where the β is the circuit correction coefficient, which can be measured by the device at the factory, β also can be corrected according to the known theoretical reflection coefficient and the known true reflection coefficient acquired by measurement.

Referring to FIG. 1 to FIG. 5, in an optional embodiment, the calculation of the subsurface velocity model and density model according to the surface parameters comprises:
a plurality of set positions are arranged on the surface to detect the first seismic wave and the second seismic wave at each set location;

According to the first seismic wave and the second seismic wave at each set location, the surface density and surface velocity at each set location can be obtained;
construct an initial near-surface model according to the density of air, the velocity of air, the surface density, and the surface velocity at each set location;

According to the initial near-surface model, the full waveform inversion algorithm is used to obtain the underground velocity model and the density model, wherein the inverted underground velocity model matches the actual underground velocity, and the inverted density model matches the actual underground density.

It should be noted that the “inverted underground velocity model matches the actual underground velocity, and the inverted density model matches the actual underground density” can refer to: the highest nyquist frequency that reaches data sampling, which is related to the target body velocity, according to the calculation power and needs, the highest calculation to: vₘᵢₙ/(4*fₘₐₓ) grid, where vₘᵢₙ is the target position speed, fₘₐₓ is the data frequency, The standard can be determined according to the oil exploration agency's own computing power and production demand, and if the oil extraction agency's own computing power is high, it is biased towards smaller grids and higher precision calculations; On the contrary, if the oil extraction agency itself has insufficient computing power, it will be biased to a larger grid according to its own needs for corresponding processing.

In the Full Waveform Inversion algorithm (FWI) is to make full use of various wave field information in seismic waves, such as amplitude, spectrum, phase, reflection, refraction, scattering, etc., to quantitatively invert the structure and properties of underground media.

The full waveform inversion algorithm has been put into production in the seismic data processing industry, especially in offshore exploration. However, the application effect of land exploration has not been satisfactory.

The inventor of the present disclosure found that the application of the full waveform inversion algorithm in land exploration has been unsatisfactory, and the current full waveform inversion algorithm can not solve the problem of inconsistency of the coupling of the geophone and the surface well. In other words, the physical properties of the contact layer between the land surface and the air vary widely, the reflection coefficient can be between 0 and −1, and even the seismic signal of the same place will change greatly with the climate and environmental changes at different collection times.

On the other hand, whether explosives or vibrators are used in land exploration sources, they change with the surface nature and environmental factors of the location of the seismic point, and it is difficult to achieve source consistency. These problems make it difficult for the current wave equation forward algorithm to simulate the actual wave field well, which seriously affects the application effect of the full waveform inversion algorithm in onshore oil exploration.

For this reason, the present disclosure uses the detection of the second seismic wave collected penetrates the surface to the air, and the first seismic wave received by the geophone on surface, accurately obtains the actual reflection coefficient, surface velocity, surface density and other physical properties of the surface, uses these properties as the initial surface model, overlays the air layer model with velocity and density, using the consistency of air coupling, the source wavelet and the detection point wave can be obtained, and the wavelet is used to correct the observation data or full-wave inversion and forward simulation data. It can ensure the consistency of observation data and forward simulation data to the greatest extent; In full-wave inversion, the upper boundary condition of the air layer surface is set as the absorption boundary, which better fits the surface boundary conditions of the real world. Accurate full-waveform inversion can be achieved. Starting from the surface air, the underground velocity and density models are accurately inverted, and finally the underground structure without ambiguity is provided, which solves the problem that there are personal subjective factors in the data processing results and the uncertainty caused thereby, resulting in unreliable imaging results, and the processing results are very large errors with actual engineering and drilling.

It should be noted that using the consistency of air coupling with Higsensitive pickup, source wavelets and receiver wavelets can be obtained, for example:

First, assume an initialized source wavelet function, and then build the initial velocity and density model, through forward evolution (can be wave equation, if the medium is simple, or the surface structure is simple, it can also be a ray algorithm), the simulated direct wave recording d(\vec{x}ₛ, t, \vec{x}ᵣ) is generated, and the real collected direct wave record is D(\vec{x}ₛ, t, \vec{x}ᵣ), and then design an objective function obj(d(\vec{x}ₛ, t, \vec{x}ᵣ), D(\vec{x}ₛ, t, \vec{x}ᵣ), simulate when the direct wave recording and the real direct wave recording are the most similar, the hypothetical source function ƒ₀(t) is consistent with the real source function, stop iterating at this time, and obtain the real source function; Otherwise, using the discorrelation of the two direct wave records, construct a gradient function g, correct the input wavelet with the gradient function g, obtain the initial wavelet of the next round of forward simulation, and continue to iterate until the direct wave produced by the forward simulation has the highest similarity with the real direct wave, the objective function is less than a specific threshold, iterative convergence, and finally a reliable source wavelet function is obtained.

The quantitative description problem of surface inconsistency is solved, so that the full waveform inversion algorithm can be used in land seismic exploration. Therefore, the accuracy and effectiveness of onshore seismic exploration results can be greatly improved, the risk of onshore oil exploration and development will be reduced, the cycle of onshore oil exploration will be shortened, and new opportunities will be brought to increase production and efficiency in the energy industry.

In an optional embodiment, the initial near-surface model is an initial near-surface model covering the air layer, the air layer contains at least two parameters of air density and air velocity, and the upper boundary of the air layer is set as the absorption boundary.

The upper boundary of the air layer of the full-waveform inversion algorithm is set as the absorption boundary, which solves the complex problem of land full-waveform inversion of the land surface boundary. The surface model covering the air layer adopts absorption boundary conditions, which ensures the consistency and simplicity of the surface model realized by full waveform inversion. And make the subsequent inversion algorithm more accurate, and obtain more accurate underground velocity model and density model.

Referring to FIG. 1 to FIG. 5, in an optional embodiment, according to the initial near-surface model, the underground velocity model and density model are obtained by using a full-waveform inversion algorithm includes: using a single shot initial wave to invert the wavelet morphology of each excitation source to obtain the source wavelet function, according to the source wavelet function, using the full-waveform inversion algorithm to obtain the underground velocity model and density model, so that the wave field forward results are consistent with the observed data.

Considering that seismic waves are spherically diffused after excitation, the reflected waves diffused into the ground will have a large change in the morphology of the wavelets due to the filtering effect formed by various factors such as dielectric wave impedance changes and absorption attenuation. Therefore, the reflected wave is difficult to use to invert the source wavelet function.

The direct wave on the surface, especially the direct wave in the air component, has no other factors affecting the waveform except for the energy attenuation caused by simple spherical diffusion, so the wave equation inversion or ray can be used to obtain an accurate and reliable source wavelet function; Therefore, the source wavelet function can be obtained by inverting the wavelet morphology of each excitation source by using the single shot initial wave in the direct wave on the surface. Thus, it provides an optimal solution for obtaining accurate source wavelet functions on land. In addition, the source wavelet function here is actually the waveform of the shock wave generated from the beginning of the detonation of the source to the end of the explosion, which can be considered as a time amplitude function from the time 0 of source excitation, which is actually used as the source function, through the wave equation simulation, generate a wave field, and then record the wave field of corresponding position, which can also be said to be an input function of FWI.

For example:

$$( \frac{1}{{v}^{2}} \frac{{\partial }^{2}}{\partial {t}^{2}} - ρΔ \frac{1}{ρ} \cdot Δ ) p ( \vec{x} ; t ; \vec{s} ) = f ( \vec{x} ; t ; \vec{s} )$$

Among them, ƒ(\vec{x}, t, \vec{s}) is the source function, with information such as surface location and time.

Referring to FIG. 1 to FIG. 5, in an optional embodiment, according to the initial near-surface model, the full waveform inversion algorithm is used to obtain the underground velocity model and density model includes: the first seismic wave is shaped by the second seismic wave, where the first seismic wave is the aforementioned detection point wave, and the comprehensive observation data of the first seismic wave and the second seismic wave are obtained.

The comprehensive observation data is used to ensure that the detection point term of the forward data in the full waveform inversion is consistent with the actual data. The comprehensive observation data here is the composite data of the first seismic wave and the second seismic wave, and if the signal-to-noise ratio of the data of the second seismic wave is high enough, and the data quality is stable, it can be directly inverted without the data of the first seismic wave. However, if the signal-to-noise ratio is too low, the filter operator information of the second seismic wave data is used to correct the first seismic wave data to obtain composite data, that is, comprehensive observation data, so as to ensure that the detection point term of the forward data in the full waveform inversion is consistent with the actual data.

Referring to FIG. 1 to FIG. 5, in an optional embodiment, according to the initial near-surface model, the full waveform inversion algorithm is used to obtain the underground velocity model and the density model includes: finding the filter operator of the detection point at the set position of the surface, and the filtering operator is used for the detection point term of the simulation in the full waveform inversion, so as to eliminate the inconsistency between the forward data waveform caused by the inconsistency of the coupling of the surface detection point and the actual observation data waveform.

The second seismic wave transmitted by the vibration transmitted to the air above the surface is detected to make the filtering effect consistent, and the comprehensive observation data of the first seismic wave and the second seismic wave are obtained, and the comprehensive observation data here is marked as D_{pz}, and in the case that the consistency of the source and the detection point is guaranteed, according to the comprehensive observation data, the underground velocity model and density model are obtained by using the full waveform inversion algorithm.

The full waveform inversion algorithm is as follows: ƒ(\vec{x}, t, \vec{s}) is the source wavelet obtained by inversion and the initial near-surface model are marked as Mᵥₚₙ (velocity, density model) as input for forward performance (wave field simulation program), the data Dₘ generated by the simulation is simulated, and the residual, that is. R, is found between Dₘ and the comprehensive observation data D_{pz}. The L2 norm of residual R is less than a specific threshold, which indicates that the iterative process converges, the velocity and density model match the actual underground construction velocity and density, and the whole processing process ends, and the underground velocity model that matches the actual underground velocity and the underground density model that matches the actual underground density model are obtained.

Conversely, the L2 norm of the residual R is greater than or equal to a specific threshold ∈, and the residual is converted into a gradient function G (gradient) by the algorithm M (migration) operator, and the Mᵥₚₙ is updated with G to obtain a new velocity model M_{vρ(n+1)}, and then continue to use M_{vρ(n+1)} forward simulation to generate new data Dₘ, enter the next round of iterations, and so on repeatedly until the L2 norm of the residuals is less than a specific threshold ∈. In full waveform inversion, and the comprehensive observation data here is marked as D_{pz}, and in the case that the consistency of the source and the detection point is guaranteed, according to the comprehensive observation data, the underground velocity model and density model are obtained by using the full waveform inversion algorithm. The surface boundary condition adopts the absorption boundary above the air layer, which is more in line with the actual situation of the physical world. This makes it more realistic and accurate.

Further, the present disclosure further provides an electronic device, includes: a processor, a memory and a program or instruction stored in the memory and may run within the processor, the program or instruction is executed by the processor when the land seismic exploration method is implemented.

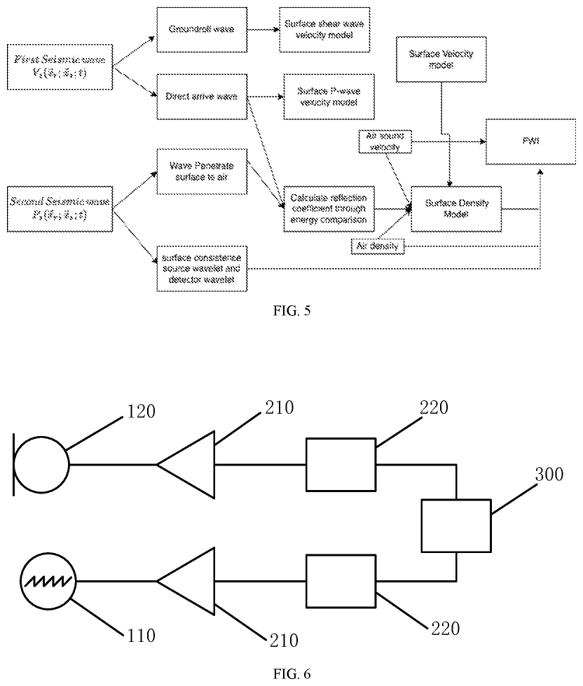

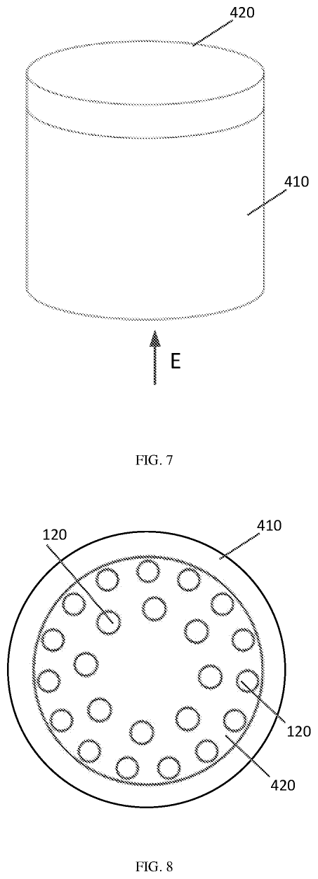

Referring to FIG. 4 to FIG. 6, in an optional embodiment, the electronic device further comprises:
Geophone 110, for disposed at the surface and detect the first seismic wave transmitted by underground vibrations to the surface;
pickup 120 for setting at a distance from the surface and detecting a second seismic wave transmitted into the air by underground vibrations; and
Sound-insulating shell 410, for a sleeve structure, the sound-insulating shell 410 may be erected along its axial direction disposed on the surface, pickup 120 disposed in one end of the axial direction of the sound-insulating shell 410. The soundproof shell 410 is used to block other noise between the surface and the pickup 120.

On the one hand, the land seismic exploration equipment uses the geophone 110 to detect the first seismic wave transmitted by the vibration to the surface at the same time, using the same meteorological conditions, the sound velocity and density of the air are consistent, through the pickup 120 to detect the second seismic wave from the surface to the air, so that the processing device can deduce various surface-related parameters such as surface density, surface velocity, actual reflection coefficient and other surface-related parameters according to the first seismic wave and the second seismic wave, to achieve the purpose of solving the surface inconsistency problem of the land seismic exploration. Therefore, the physical properties such as the actual reflection coefficient, surface velocity and surface density of the land surface are accurately obtained, and these properties are used as the initial surface model, and the air velocity density model is covered on it, and the consistency of air coupling can be used to obtain the source and detection point wavelet, and the observation data or the forward simulation data can be corrected by using the wavelets to ensure the consistency of the observation data and the forward simulation data to the Solve the problem that there are personal subjective factors in the data processing results and the uncertainty caused by them, resulting in unreliable imaging results, and very large errors between the processing results and the actual engineering and drilling results. Referring to FIGS. 4 to 6, in one optional embodiment, the electronic device further comprises a base 420, the base 420 is disposed on top of the sound enclosure 410, the pickup 120 is pluralistic, a plurality of pickups 120 is arranged on the underside of the base 420, and a plurality of pickups 120 is disposed within the sound enclosure 410.

In one optional embodiment, the base 420 is a disc structure and fixed on top of the acoustic housing 410, a plurality of pickups 120 is arranged as a plurality of rings and is disposed around the center of the base 420.

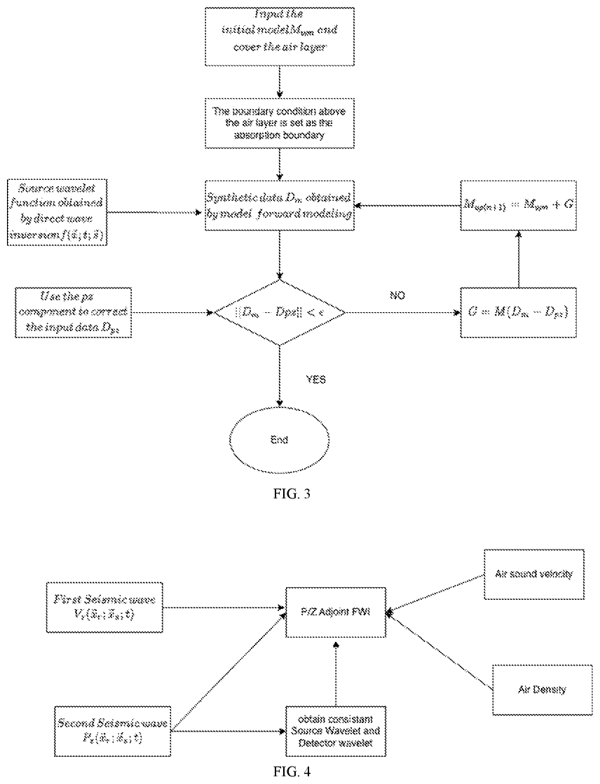

Referring to FIGS. 3 to 5, in an optional embodiment, the detector 110 is connected to the bottom of the acoustic housing 410. Realize the integrated setup, the pickup 120 and the detector 110 are integrated together, convenient for the arrangement of the detector 110 and the pickup 120.

Referring to FIG. 4 to FIG. 6, in one optional embodiment, the pickup 120 is a high sensitive pickup, and the pickup 120 is used to detect at least one of the energies of the velocity pressure component of the second seismic wave. The pickup 120 may be a vector laser air-coupled pickup, or a MEMS vector pickup, which may pick up a vibration signal from the ground through the surface to the air.

Referring to FIGS. 4 to 6, in an optional embodiment, the detector 110 is a moving coil detector, and the detector 110 is used to detect the pressure change component and/or the energy of the first seismic wave.

Of course, the geophone 110 can also be a MEMS, or even a geophone in the form of electrolyte, pendulum, etc.

Referring to FIGS. 4 to 6, in one optional embodiment, the electronic device further comprises a linear amplifier 210, an analog-to-digital conversion module 220 and an acquisition control module 300, a linear amplifier 210 is connected to an analog-to-digital conversion module 220, an analog-to-digital conversion module 220 is connected to an acquisition control module 300, and a linear amplifier 210 is connected to a pickup 120 or a detector 110.

Referring to FIG. 4 to FIG. 6, in an optional embodiment, the linear amplifier 210 and the analog-to-digital conversion module are two,
pickup 120, a linear amplifier 210, an analog-to-digital conversion module 220 connected sequentially, an analog-to-digital conversion module 220 and acquisition control module 300 connected;

The detector 110, another linear amplifier 210, another analog-to-digital conversion module 220 is connected sequentially, and another analog-to-digital conversion module 220 is connected to the acquisition control module 300.

The signal collected by the pickup 120 or the geophone 110 is amplified by the linear amplifier 210, and then transmitted to the analog-to-digital conversion module, the seismic signal is digitized, and the digitization is sent to the acquisition control module 300 and the corresponding first seismic wave or second seismic wave is recorded.

The analog-to-digital conversion module 220 here may be a high-precision analog-to-digital converter.

Further, the present disclosure also provides a readable storage medium, the readable storage medium stores programs or instructions, the program or instruction is executed by the processor when the steps to implement the land seismic exploration method.

It should be understood that the above embodiments of the present disclosure are only used to illustrate or explain the principles of the present disclosure, and do not constitute a limitation of the present disclosure. Therefore, any modification, equivalent substitution, improvement, etc. made without departing from the spirit and area of the present disclosure shall be included in the protected area of the present disclosure.

Further, the appended claims of the present disclosure are intended to cover all variations and modifications falling into the attached claim area and boundary, or in an equivalent form of such area and boundary.

1. A land seismic exploration method, comprising the following steps:
detecting a first seismic wave transmitted to the surface by vibrations generated underground or at preset locations on the surface;
detecting a second seismic wave transmitted by the vibration to the air above the surface;
calculating the surface parameters within the set range of the preset position according to the first seismic wave and the second seismic wave;
a underground velocity model and a density model are calculated according to the surface parameters.

2. The land geophysical exploration method according to claim 1, wherein, the surface parameters within the set range of the preset position are calculated according to the first seismic wave and the second seismic wave, comprising:
detecting of the first seismic wave includes detecting the energy of the first seismic wave;
detecting the second seismic wave includes detecting the energy of the second seismic wave;
a actual reflection coefficient within the set range of the preset position is calculated according to the energy of the first seismic wave and the energy of the second seismic wave.

3. The land seismic exploration method according to claim 1, wherein, according to the first seismic wave and the second seismic wave, calculate the surface parameters within the setting range of the preset position, comprising:
obtaining a direct wave or ground wave reaching a detection point at the preset position according to the first seismic wave and the second seismic wave;
the surface velocity within the set range of the preset position is calculated according to the direct wave or ground wave.

4. The land seismic exploration method according to claim 2, wherein, according to the first seismic wave and the second seismic wave, calculate the surface parameters within the setting range of the preset position, comprising:
the surface density within the set range of the preset position is obtained according to the calculation formula of the surface density,
the formula for calculating the earth surface density is:
$${ρ}_{g} = \frac{{ρ}_{air} {v}_{air} ( 1 - {r}_{g} )}{{v}_{g} ( 1 + {r}_{g} )}$$
wherein ρ_{g} is the surface density, v_{g} is the surface velocity, r_{g} is the actual reflection coefficient, vₐᵢᵣ is the air velocity within the set range of the preset position, and ρₐᵢᵣ is the air density within the set range of the preset position.

5. The land seismic exploration method according to claim 2, wherein, the underground velocity model and density model calculated according to the surface parameters comprise:
a large number of setting positions are arranged on the surface to detecting the first seismic wave and the second seismic wave at each setting position;
according to the first seismic wave and the second seismic wave at each set position, the earth surface density and surface velocity at each set position are obtained;
the initial near-surface model is constructed according to the air density, air velocity, earth surface density and surface velocity at each set position;
based on the initial near-surface model, the underground velocity model and density model are obtained by using the full waveform inversion algorithm, wherein, the underground velocity model obtained by inversion is matched with the actual underground velocity, and the underground density model obtained by inversion is matched with the actual underground density model.

6. The land seismic exploration method according to claim 5, wherein, the initial near-surface model is the initial near-surface model covering the air layer, the air layer contains at least two parameters of air density and air velocity, and the upper boundary of the air layer is set as the absorption boundary when inversion.

7. The land seismic exploration method according to claim 5, wherein, based on the initial near-surface model, the underground velocity model and density model obtained by using the full waveform inversion algorithm include:
the source wavelet function is obtained by inversion of the wavelet shape of each shot source using the first break of a single shot, and the source wavelet function is obtained at the preset position where the vibration is generated, according to the source wavelet function, using the full waveform inversion algorithm to obtain the underground velocity model and density model, so that the wave field forward result is consistent with the actual data.

8. The land seismic exploration method according to claim 5, wherein, based on the initial near-surface model, the full waveform inversion algorithm is used to obtain the underground velocity model and density model, comprising:
the second seismic wave is used to shape the first seismic wavelet to obtain the comprehensive observation data of the first seismic wave and the second seismic wave, and the comprehensive observation data is used to ensure that the detection point term of the forward data in the full waveform inversion is consistent with the actual data.

9. The land seismic exploration method according to claim 5, wherein according to the initial near-surface model, the full waveform inversion algorithm is used to obtain an underground velocity model and a density model comprising:
a filter operator of the detection point at the set position of the surface is jointly calculated by the second seismic wave and the first seismic wave, and the filter operator is used for the detection point term of the simulation in the full waveform inversion, so as to eliminate the inconsistency between the forward data waveform and the actual data waveform caused by the inconsistency of coupling of the surface detection point.

10. An electronic device comprising:
a processor, a memory and a program or instruction stored in the memory and may run within the processor, the program or instruction is executed by the processor and a step to realize any of the land seismic exploration methods of claim 1.

11. The electronic device according to claim 10, wherein the electronic device further comprises:
a geophones for setting at the surface and detecting the first seismic waves transmitted by underground vibrations to the surface; and
a pickup for setting at a distance from the surface and detecting the second seismic wave transmitted into the air by the shaking.

12. The electronic device according to claim 11, wherein the electronic device further comprises:
a sound insulation shell is a sleeve structure, the sound insulation shell is used for erection and disposed on the surface, and the pickup is disposed within one end of the axial direction of the sound insulation shell.

13. The electronic device according to claim 10, wherein the electronic device further comprises a linear amplifier, an analog-to-digital conversion module, an acquisition control module, the linear amplifier is connected to the analog-to-digital conversion module, the analog-to-digital conversion module is connected to the acquisition control module, and the linear amplifier is connected to the pickup or the geophone.

14. A readable storage medium wherein the readable storage medium stores a program or instruction that is executed by the processor and is executed by the processor to implement the land seismic exploration method as described in claim 1.

15. The land seismic exploration method according to claim 3, wherein, the underground velocity model and density model calculated according to the surface parameters comprise:
a large number of setting positions are arranged on the surface to detecting the first seismic wave and the second seismic wave at each setting position;
according to the first seismic wave and the second seismic wave at each set position, the earth surface density and surface velocity at each set position are obtained;
the initial near-surface model is constructed according to the air density, air velocity, earth surface density and surface velocity at each set position;
based on the initial near-surface model, the underground velocity model and density model are obtained by using the full waveform inversion algorithm, wherein, the underground velocity model obtained by inversion is matched with the actual underground velocity, and the underground density model obtained by inversion is matched with the actual underground density model.

16. The land seismic exploration method according to claim 4, wherein, the underground velocity model and density model calculated according to the surface parameters comprise:
a large number of setting positions are arranged on the surface to detecting the first seismic wave and the second seismic wave at each setting position;
according to the first seismic wave and the second seismic wave at each set position, the earth surface density and surface velocity at each set position are obtained;
the initial near-surface model is constructed according to the air density, air velocity, earth surface density and surface velocity at each set position;
based on the initial near-surface model, the underground velocity model and density model are obtained by using the full waveform inversion algorithm, wherein, the underground velocity model obtained by inversion is matched with the actual underground velocity, and the underground density model obtained by inversion is matched with the actual underground density model.

17. The electronic device of claim 10, wherein, the surface parameters within the set range of the preset position are calculated according to the first seismic wave and the second seismic wave, comprising:
detecting of the first seismic wave includes detecting the energy of the first seismic wave;
detecting the second seismic wave includes detecting the energy of the second seismic wave;
a actual reflection coefficient within the set range of the preset position is calculated according to the energy of the first seismic wave and the energy of the second seismic wave.

18. The electronic device of claim 10, wherein, according to the first seismic wave and the second seismic wave, calculate the surface parameters within the setting range of the preset position, comprising:
obtaining a direct wave or ground wave reaching a detection point at the preset position according to the first seismic wave and the second seismic wave;
the surface velocity within the set range of the preset position is calculated according to the direct wave or ground wave.

19. The electronic device of claim 17, wherein, according to the first seismic wave and the second seismic wave, calculate the surface parameters within the setting range of the preset position, comprising:
the surface density within the set range of the preset position is obtained according to the calculation formula of the surface density, the formula for calculating the earth surface density is:
$${ρ}_{g} = \frac{{ρ}_{air} {v}_{air} ( 1 - {r}_{g} )}{{v}_{g} ( 1 + {r}_{g} )}$$
wherein ρ_{g} is the surface density, v_{g} is the surface velocity, r_{g} is the actual reflection coefficient, vₐᵢᵣ is the air velocity within the set range of the preset position, and ρₐᵢᵣ is the air density within the set range of the preset position.

20. The electronic device of claim 17, wherein, the underground velocity model and density model calculated according to the surface parameters comprise:
a large number of setting positions are arranged on the surface to detecting the first seismic wave and the second seismic wave at each setting position;
according to the first seismic wave and the second seismic wave at each set position, the earth surface density and surface velocity at each set position are obtained;
the initial near-surface model is constructed according to the air density, air velocity, earth surface density and surface velocity at each set position;
based on the initial near-surface model, the underground velocity model and density model are obtained by using the full waveform inversion algorithm, wherein, the underground velocity model obtained by inversion is matched with the actual underground velocity, and the underground density model obtained by inversion is matched with the actual underground density model.
